(19) United States
(12) Patent Application Publication
(10) Pub. No.: US 2016/0283922 A1
(43) Pub. Date: Sep. 29, 2016

(54) INFORMATION PROCESSING DEVICE, INFORMATION PROCESSING METHOD, INFORMATION PROCESSING PROGRAM, AND STORAGE MEDIUM STORING INFORMATION PROCESSING PROGRAM

(71) Applicant: RAKUTEN, INC., Tokyo (JP)

(72) Inventors: Yutaka JINNO, Tokyo (JP); Hideki AKASHIKA, Tokyo (JP)

(73) Assignee: Rakuten, Inc., Tokyo (JP)

(21) Appl. No.: 14/392,255

(22) PCT Filed: Jun. 26, 2013
(86) PCT No.: PCT/JP2013/067549

§ 371 Date: Jun. 17, 2016

(51) Int. Cl. G06Q 20/10; G06Q 20/34

(52) U.S. Cl. CPC G06Q 20/105; G06Q 20/34

(57) ABSTRACT

A determination is made as to whether an event corresponding to log data not yet managed by an electronic money server 4 is present based on log data managed by the electronic money server 4 and log data acquired from an electronic money card 1, and when it is determined that the event is present, a processing assuming the presence of the event is performed.

### TECHNICAL FIELD

The present invention relates to a technical field of devices for managing time-series information generated for events using a portable device such as IC chip.

### BACKGROUND ART

There has been conventionally known, for example, a transaction device in which a card transaction history is read from an IC chip or a database to be displayed on an operation screen on insertion of a card, wherein the card transaction history is stored in the IC chip mounted on the card or the database in a server device connected to a network.(Patent Literature 1, for example)

### CITATION LIST

### Patent Literature

Patent Literature 1: JP 2004-126834 A

### SUMMARY OF THE INVENTION

### Problem to be Solved by the Invention

If a payment method for which a specific company is in charge of payments for transactions (transactions between sellers and purchasers) using the IC chips is selected, time-series information such as log data for the transactions is stored in the IC chip in real time on payment, but may take a long time to be managed in the company's system. This is because the time-series information depends on sellers' operations and is not necessarily provided from the sellers to the company in real time. In such a case, the company cannot perform a series of processing such as information provision depending on an event such as transaction corresponding to non-managed (grasped) time-series information.

It is an object of the present invention to provide an information processing device, an information processing method, an information processing program, and a storage medium storing the information processing program capable of performing a series of predetermined processing depending on events such as transactions already made but not-yet-managed on a company.

### Solution to Problem

In order to solve the above problem, the invention of claim 1 is an information processing device for managing time-series information generated for events using a portable device, comprising:

an acquisition means that acquires time-series information stored in the portable device from the portable device storing the time-series information generated for events using the portable device;

a determination means that determines whether an event corresponding to time-series information not yet managed by the information processing device is present based on the time-series information managed by the information processing device and the time-series information acquired by the acquisition means; and

a processing means that, when the determination means determines that the event is present, performs a processing assuming the presence of the event.

According to the invention, it is possible to perform a predetermined processing depending on an event already-made but not-yet-managed in the company.

The invention of claim 2 is the information processing device according to claim 1,

wherein the processing means performs a processing of providing a user with provision information capable of being provided to the user of the portable device when a predetermined condition is met assuming the presence of the event determined by the determination means.

According to the invention, it is possible to provide the user with information at a conventionally-impossible timing.

The invention of claim 3 is the information processing device according to claim 2,

wherein the number of items of the time-series information capable of being stored in the portable device is limited to a predetermined number of items, and

the determination means determines whether an event other than the events corresponding to the time-series information acquired by the acquisition means is present only when required for determining the predetermined condition.

According to the invention, it is possible to reduce a processing load for estimating whether an event other than the events corresponding to the time-series information acquired by the acquisition means is present.

The invention of claim 4 is the information processing device according to claim 2 or 3, further comprising:

a specification means that specifies information enough to determine whether the predetermined condition is met; and

a condition determination means that determines whether the predetermined condition is met based on the specified contents.

According to the invention, it is possible to reduce a processing load for determining whether the predetermined condition is met.

The invention of claim 5 is the information processing device according to claim 4,

wherein the time-series information includes at least one of the serial numbers of the time-series information per portable device and the balance after the events corresponding to the time-series information, and

the specification means specifies information enough to determine whether the predetermined condition is met based on at least one of the serial numbers of the time-series information and the balance.

According to the invention, it is possible to appropriately specify information enough to determine whether the predetermined condition is met.

The invention of claim 6 is the information processing device according to any one of claims 2 to 5,

wherein when the predetermined condition is not met, the processing means performs a processing of providing the user with information indicating items required for meeting the predetermined condition assuming the presence of the event.

According to the invention, it is possible to promote the user to use the portable device.

The invention of claim 7 is the information processing device according to claim 1,

wherein when a predetermined condition is not met even assuming the presence of the event determined by the determination means, the processing means performs a processing of providing the user with information indicating items required for meeting the predetermined condition assuming the presence of the event.

According to the invention, it is possible to promote the user to use the portable terminal.

The invention of claim 8 is the information processing device according to claim 1,

wherein the determination means determines whether an event other than the events corresponding to the time-series information acquired by the acquisition means is present.

According to the invention, it is possible to perform a predetermined processing assuming the presence of an event other than the events corresponding to the time-series information acquired by the acquisition means.

The invention of claim 9 is the information processing device according to claim 8,

wherein the time-series information includes the balance after the events corresponding to the time-series information,

the device further comprising a check means that checks the presence of an unauthorized event based on a transition of the balance.

According to the invention, it is possible to notify unauthorized use of the portable device to the user.

The invention of claim 10 is an information processing method performed by an information processing device for managing time-series information generated for events using a portable device, the method comprising:

an acquisition step of acquiring time-series information stored in the portable device from the portable device storing the time-series information generated for events using the portable device;

a determination step of determining whether an event corresponding to time-series information not yet managed by the information processing device is present based on the time-series information managed by the information processing device and the time-series information acquired in the acquisition step; and

a processing step of, when the event is determined as present in the determination step, performing a processing assuming the presence of the event.

The invention of claim 11 is an information processing program for causing a computer for managing time-series information generated for events using a portable device to perform:

an acquisition step of acquiring time-series information stored in the portable device from the portable device storing the time-series information generated for events using the portable device;

a determination step of determining whether an event corresponding to time-series information not yet managed by the information processing device is present based on the time-series information managed by the information processing device and the time-series information acquired in the acquisition step; and

a processing step of, when the event is determined as present in the determination step, performing a processing assuming the presence of the event.

The invention of claim 12 is a storage medium storing an information processing program for causing a computer for managing time-series information generated for events using a portable device to perform:

an acquisition step of acquiring time-series information stored in the portable device from the portable device storing the time-series information generated for events using the portable device;

a determination step of determining whether an event corresponding to time-series information not yet managed by the information processing device is present based on the time-series information managed by the information processing device and the time-series information acquired in the acquisition step; and a processing step of, when the event is determined as present in the determination step, performing a processing assuming the presence of the event.

### Advantageous Effects of the Invention

According to the present invention, it is possible to perform a predetermined processing depending on an event already made but not-yet-managed by a company.

### BRIEF DESCRIPTION OF THE DRAWINGS

FIG. 1 is a diagram illustrating an exemplary schematic structure of an electronic money system S according to an exemplary embodiment.

FIG. 2 is a diagram illustrating an exemplary schematic structure of a portable terminal 3 according to the exemplary embodiment.

FIG. 3A to FIG. 3C are the diagrams illustrating exemplary displacement events of parts of interest.

FIG. 4A is a diagram illustrating an exemplary schematic structure of an electronic money server 4 according to the exemplary embodiment, and FIG. 4B is a diagram illustrating exemplary functional blocks in a system control unit 43.

FIG. 5 is a diagram illustrating examples of contents of log data acquired from a non-contact IC chip la and contents of log data acquired from a log database 42c.

FIG. 6 is a diagram illustrating other examples of contents of log data acquired from the non-contact IC chip 1a and contents of log data acquired from the log database 42c.

FIG. 7 is a sequence diagram illustrating exemplary operations performed in the electronic money system S.

FIG. 8A to FIG. 8C are the diagrams illustrating exemplary screen display on a display D of a portable terminal 2.

FIG. 9 is a flowchart illustrating an event presence determination and an information provision processing by way of example.

### DESCRIPTION OF THE EMBODIMENTS

An exemplary embodiment according to the present invention will be described below with reference to the drawings. The exemplary embodiment described below is such that the present invention is applied to an electronic money system. [1. Schematic Structure of Schematic Structure of Electronic Money System S]

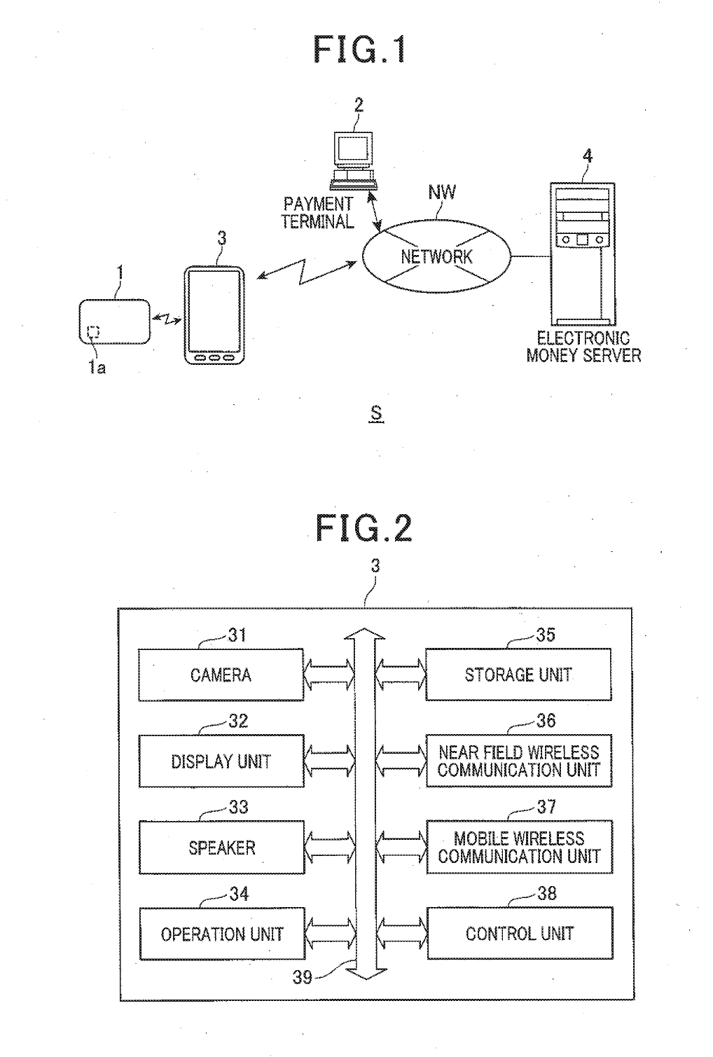

An exemplary schematic structure of an electronic money system S according to the present exemplary embodiment will be first described with reference to FIG. 1. FIG. 1 is a diagram illustrating an exemplary schematic structure of the electronic money system S according to the present exemplary embodiment. As illustrated in FIG. 1, the electronic money system S according to the present exemplary embodiment is configured of an electronic money card 1, a payment terminal 2, a portable terminal 3, an electronic money server 4, and the like. According to the present exemplary embodiment, the description will be made byway of a non-contact IC chip mounted on the electronic money card 1 as a portable device. However, the non-contact IC chip may be incorporated as IC module in the portable terminal 3. In this case, the portable terminal 3 or the IC module incorporated in the portable terminal 3 is a portable device according to the present invention. The electronic money card 1 and the portable terminal 3 are carried by the same user. The user is a member making a contract for use of the electronic money card 1 with a company issuing the electronic money card 1, for example. The payment terminal 2 is installed at each shop selling products or providing services. The shop is a member shop making a contract as a shop capable of accepting the electronic money card 1 with the company issuing the electronic money card 1, for example. The electronic money server 4 is an exemplary information processing device according to the present invention. The electronic money server 4 is managed by the company issuing the electronic money card 1, for example. The electronic money server 4 is connected to a network NW. The payment terminal 2 and the portable terminal 3 can access the electronic money server 4 via the network NW. The network NW is configured of a dedicated line, a mobile communication network, Internet, or the like.

The electronic money card 1 is a plate-shaped card whose dimension is defined under the international standard or the like, for example. The electronic money card 1 includes a non-contact IC chip la having a storage unit (such as nonvolatile memory) and a processing unit (such as CPU), an antenna, and the like. The non-contact IC chip la is an IC module employing the near field communication (NFC) technique using a frequency of 13.56 MHz band, for example.

The storage unit in the non-contact IC chip 1a stores therein balance data indicating a balance of electronic value, log data, electronic money number, and the like. The electronic value is electronic information corresponding to money value, or stored value type prepaid electronic money. The electronic money number is identification information for discriminating the balance of the electronic value from the balance of the electronic value of other electronic money card, for example. The log data is exemplary time-series information (or temporal information). The log data includes transaction history data and charge history data, for example. The transaction history data is information generated for transactions (exemplary events) for which the electronic money card 1 is used for payment at shops, for example. The transaction history data includes data such as electronic money number, transaction time/date, transacted amount, and shop ID of transaction shop. The shop ID is identification information uniquely given to each shop. The charge history data is information generated for charges (exemplary events) for which the electronic money card 1 is used at shops, for example. To charge is to increase the balance of the electronic value stored in the storage unit in the non-contact IC chip 1a. The charge history data includes data such as electronic money number, charge time/date, charged amount, and shop ID of a shop where charging is performed. The log data includes either the serial numbers of the log data per electronic money card 1 (or the non-contact IC chip 1a) or the balance after the events (transaction or charge) corresponding to the log data. The serial number indicates an order stored in the storage unit in the non-contact IC chip 1a, for example. That is, a higher serial number is given to later-stored log data. The storage unit in the non-contact IC chip 1a has a small data storage capacity, and thus the log data capable of being stored in the storage unit is limited to several items. Therefore, when more than a limited number of items of log data are stored, the oldest log data is deleted and the latest log data is stored by the processing unit. Thereby, a limited number of items of latest log data are stored in the storage unit in the non-contact IC chip 1a.

The processing unit in the non-contact IC chip 1a performs a balance change processing of changing the balance data stored in the storage unit by use of balance change information transmitted from the payment terminal 2 within a near field communicable range, and sends the processing result to the payment terminal 2. The processing unit in the non-contact IC chip 1a reads the log data stored in the storage unit and transmits the log data to the portable terminal 3 in response to a request from the portable terminal 3 within the near field communicable range.

The payment terminal 2 is a Point Of Sales (POS) terminal having an electronic value payment function, for example. The payment terminal 2 is connected with a reader/writer employing the near field communication technique. For example, when a shop and a user make a transaction in the shop (for example when the user purchases a product or is provided with a service), for example, a predetermined payment operation in which the payment amount is input into the payment terminal 2 by a sales clerk is performed and the electronic money card 1 is held over the reader/writer. The payment terminal 2 then requests the electronic money number and the current balance of the electronic value to the electronic money card 1 via the reader/writer. The non-contact IC chip 1a (the processing unit) in the electronic money card 1 reads the electronic money number and the balance data stored in the storage unit in response to the request, and transmits the electronic money number and the balance data to the payment terminal 2. The payment terminal 2 compares the balance of the electronic value indicated by the balance data received from the electronic money card 1 with the payment amount, and if the balance is the payment amount or more, generates transaction history data for the transaction. The payment terminal 2 then transmits the generated transaction history data and the balance change information for changing the balance of the electronic value (or decreasing the payment amount from the balance) to the electronic money card 1 via the reader/writer. The non-contact IC chip 1a (the processing unit) in the electronic money card 1 performs the balance change processing of changing the balance data stored in the storage unit (or the processing of decreasing and rewriting the balance) and stores the transaction history data as log data in the storage unit in response to the transaction history data and the balance change information from the payment terminal 2, and sends the processing result to the payment terminal 2. In this way, the transaction history data is stored as log data in the non-contact IC chip 1a in real time on transaction. On the other hand, the payment terminal 2 stores the generated transaction history data as log data in a storage unit provided in the payment terminal 2.

For example, when the user charges electronic value at a shop, the amount to be charged (money) is passed from the user to a sales clerk, the amount to be charged is then input into the payment terminal 2 by the sales clerk thereby to perform a predetermined charge operation, and the electronic money card 1 is held over the reader/writer. The payment terminal 2 then requests the electronic money number and the current balance of the electronic value to the electronic money card 1 via the reader/writer. The non-contact IC chip 1a (the processing unit) in the electronic money card 1 reads the electronic money number and the balance data stored in the storage unit in response to the request, and transmits the electronic money number and the balance data to the payment terminal 2. The payment terminal 2 compares the amount in which the charged amount is added to the balance of the electronic value indicated by the balance data received from the electronic money card 1, with a predetermined limited amount, and when the added amount is less than the limited amount, generates charge history data for the charge. The payment terminal 2 then transmits the generated charge history data and the balance change information for changing the balance of the electronic value (or adding the charged amount to the balance) to the electronic money card 1 via the reader/writer. The non-contact IC chip 1a (the processing unit) in the electronic money card 1 performs the balance change processing of changing the balance data stored in the storage unit (or increasing and rewriting the balance) and stores the charge history data in the storage unit in response to the charge history data and the balance change information from the payment terminal 2, and sends the processing result to the payment terminal 2. In this way, the charge history data is stored as log data in the non-contact IC chip 1a in real time on charge. On the other hand, the payment terminal 2 stores the generated charge history data as log data in the storage unit provided in the payment terminal 2. The charged amount may be input from a credit card company to a shop by use of a user's credit card.

The payment terminal 2 then accesses the electronic money server 4 via the network NW every predetermined time (such as 24 hours) by a batch processing, for example, and transmits the log data stored in the storage unit to the electronic money server 4.

Then, FIG. 2 is a diagram illustrating an exemplary schematic structure of the portable terminal 3 according to the present exemplary embodiment. The portable terminal 3 is configured of a camera 31, a display unit 32, a speaker 33, an operation unit 34, a storage unit 35, a near field wireless communication unit 36, a mobile wireless communication unit 37, a control unit 38, and the like as illustrated in FIG. 2. The camera 31, the display unit 32, the speaker 33, the operation unit 34, the storage unit 35, the near field wireless communication unit 36, and the mobile wireless communication unit 37 are connected to the control unit 38 via an I/O interface unit (not illustrated) and a bus 39. The portable terminal 3 is portable by a user, and is applicable to Smartphone, cell phone, game player, tablet computer, and the like.

The camera 31 is installed on the back of the portable terminal 3, for example, and is directed for shooting (taking an image of) a subject in response to a user's instruction. An image shot by the camera 31 is stored in an image storage area assigned to the storage unit 35, for example, and is displayed on a display D of the display unit 32. The display unit 32 is configured of the touch panel display D or the like, for example. The display D is installed on the front of the portable terminal 3, for example, and is directed for displaying a screen on which user-available icons are arranged, an image of the electronic money card 1 shot by the camera 31, or the like in response to a control signal from the control unit 38. The speaker 33 outputs a speech signal from the control unit 38 as speech to the outside. The operation unit 34 is configured of input buttons for inputting user's instructions. The operation unit 34 can input instructions via the icons displayed on the touch panel display D.

The storage unit 35 is configured of a nonvolatile memory such as flash memory or EEPROM. The storage unit 35 stores therein the operating system, various application programs, and the like. The near field wireless communication unit 36 is configured of an IC module employing the near field communication technique, an antenna, and the like. When the electronic money card 1 approaches the near field communicable range, the near field wireless communication unit 36 makes communication with the non-contact IC chip la in the electronic money card 1. The mobile wireless communication unit 37 is configured to make wireless communication with a base station in the mobile communication network. Thereby, the control unit 38 can access the electronic money server 4 via the network NW thereby to make communication with the electronic money server 4.

The control unit 38 is configured of CPU, ROM, RAM, and the like, for example. The control unit 38 performs a series of processing according to the application programs stored in the storage unit 35, for example. When the user makes the electronic money card 1 and the portable terminal 3 close to the near field communicable range and makes a predetermined instruction from the operation unit 34, the control unit 38 requests log data to the electronic money card 1 via the near field wireless communication unit 36. The non-contact IC chip 1a (the processing unit) in the electronic money card 1 reads the log data stored in the storage unit in response to the request, and transmits the log data to the portable terminal 3. The control unit 38 then acquires the log data from the electronic money card 1. At this time, the control unit 38 may be configured to acquire the balance data together with the log data from the electronic money card 1. The log data stored in the storage unit 35 is transmitted to the electronic money server 4 via the mobile wireless communication unit 37.

When the user makes a predetermined instruction from the operation unit 34 while the electronic money card 1 and the portable terminal 3 are close to each other, the camera 31 is activated and the control unit 38 starts capturing a series of images continuously shot by the camera 31 at predetermined shooting intervals. The control unit 38 determines a specifiable part of interest with reference to the edge of the electronic money card 1 appearing on a reference image configuring the series of captured images. For example, the control unit 38 detects a linear edge of the electronic money card 1 appearing on the reference image and determines the detected linear edge as a part of interest. For example, a first linear edge of the electronic money card 1 appearing on the reference image is assumed as a first part of interest, and a second linear edge orthogonal to the first edge is detected as a second part of interest. The control unit 38 then detects a displacement event indicating that the determined parts of interest displace at any of a plurality of comparative images following the reference image.

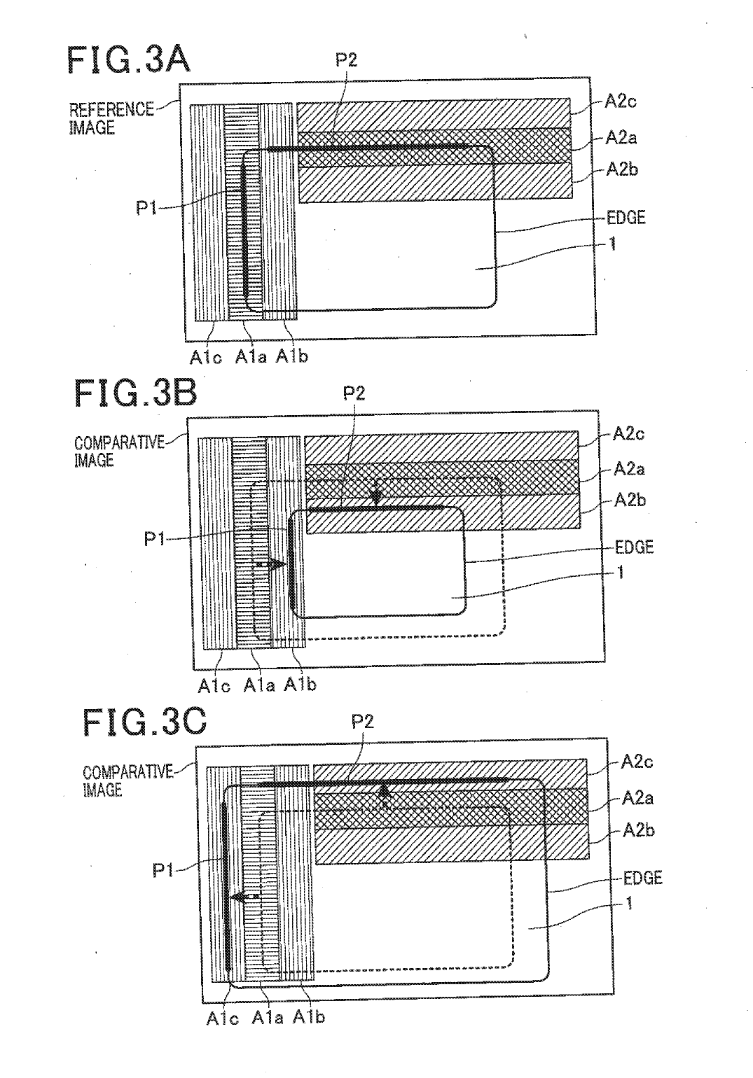

FIG. 3A to FIG. 3C are the diagrams illustrating exemplary displacement events of the parts of interest. In the examples of FIGS. 3A to 3C, the electronic money card 1 having a substantially rectangular edge appears on the reference image and the comparative images, respectively. In the examples of FIGS. 3A to 3C, A1a, A1b, A1c, A2a, A2b, and A2c indicate the areas on the image frame, respectively, and the control unit 38 discriminately recognizes the areas. In the example of FIG. 3A, the control unit 38 determines a linear edge included in the area A1a in the edge of the electronic money card 1 appearing on the reference image as a first part P1 of interest, and determines a linear edge partially included in the area A2a as a second part P2 of interest. Then, in the comparative image after the user makes the electronic money card 1 and the portable terminal 2 away from each other from the state illustrated in FIG. 3A, the part P1 of interest displaces from the area A1a to the area A1b and the part P2 of interest displaces from the area A2a to the area A2b as illustrated in FIG. 3B. On the other hand, in the comparative image after the user makes the electronic money card 1 and the portable terminal 2 close to each other from the state illustrated in FIG. 3A, the part P1 of interest displaces from the area A1a to the area A1c and the part P2 of interest displaces from the area A2a to the area A2c as illustrated in FIG. 3C. The control unit 38 discriminately detects the first displacement event in which the part P1 of interest and the part P2 of interest displace to the inward areas (A1b, A2b) as illustrated in FIG. 3B and the second displacement event in which the part P1 of interest and the part P2 of interest displace to the outward areas (A1c, A2c) as illustrated in FIG. 3C. The control unit 38 sets an information type corresponding to the detected first displacement event or second displacement event (such as an information type associated with each displacement event on the program). The information type indicates benefit information such as coupon, or a log, for example. The control unit 38 then accesses the electronic money server 4 via the near field wireless communication unit 36 thereby to acquire provision information depending on the set information type from the electronic money server 4. Herein, there is set, for example, such that the provision information depending on the information type corresponding to the first displacement event is benefit information such as coupon, and the provision information depending on the information type corresponding to the second displacement event is log data. The benefit information is information indicating that a special favor or treatment such as discount can be given from a shop on payment for a product or service. The provision information acquired from the electronic money server 4 is displayed on the display D of the display unit 32. In particular, when the provision information acquired from the electronic money server 4 is log data, the log data acquired from the electronic money card 1 and the log data acquired from the electronic money server 4 are integrated to be displayed on the display D.

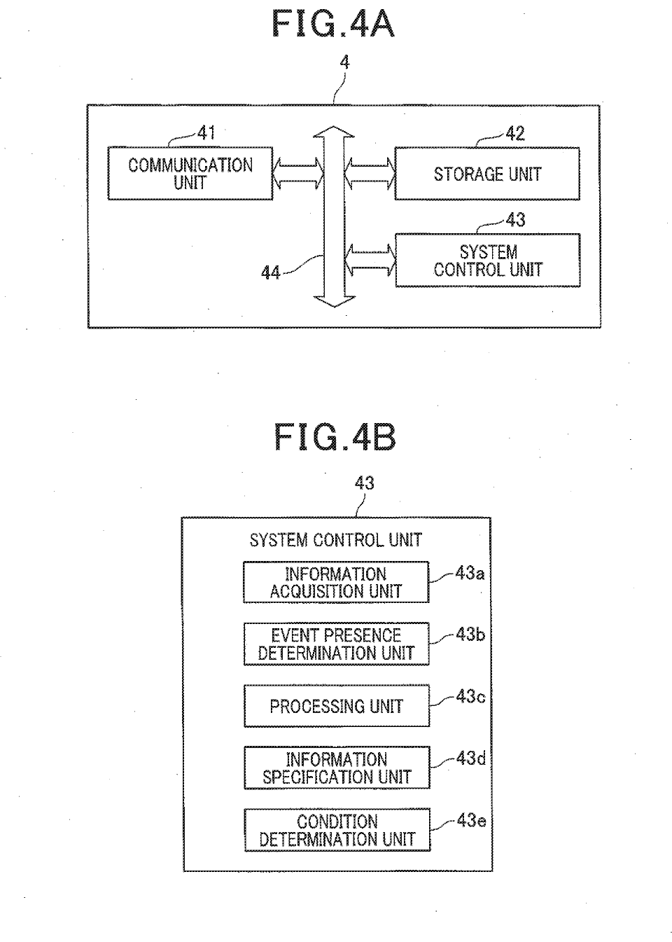

Then, FIG. 4A is a diagram illustrating an exemplary schematic structure of the electronic money server 4 according to the present exemplary embodiment. The electronic money server 4 is directed for managing the log data thereby to manage a transition of money value of the electronic value. The electronic money server 4 includes a communication unit 41, a storage unit 42, a system control unit 43, and the like as illustrated in FIG. 4A, and the components are connected to a bus 44. The communication unit 41 is connected to the network NW to control a communication state.

The storage unit 42 is configured of a hard disk drive or the like, for example, and stores therein the operating system and various programs such as server processing programs (including the information processing program according to the present invention). The server processing programs are directed for causing a computer to perform a processing in each step described later. The server processing programs may be downloaded from a predetermined server or the like via the network NW, or may be recorded and read in a storage medium such as CD or DVD.

The storage unit 42 is provided with a user information database (DB) 42a, a shop information database (DB) 42b, and a log database (DB) 42c. The user information database 42a registers user information of users (members) of the electronic money cards per user. Herein, the user information includes user ID, password, user name, address, phone number, e-mail address, and electronic money number, for example. The user ID is identification information uniquely given to each user. The shop information database 42b registers therein shop information of shops (member shops) capable of accepting the electronic money card per shop. The shop information includes shop ID, password, shop name, address, phone number, and e-mail address, for example. The log database 42c registers therein log data to be transmitted from the payment terminal 2 to the electronic money server 4 via the network NW every predetermined time. The electronic money server 4 manages the log data by the log database 42c. The user information database (DB) 42a, the shop information database (DB) 42b, and the log database (DB) 42c may not be provided in the storage unit 42 but may be provided in a different server from the electronic money server 4.

The system control unit 43 is configured of a CPU 43a, a ROM 43b, a RAM 43c, and the like. FIG. 4B is a diagram illustrating exemplary functional blocks in the system control unit 43. The system control unit 43 as a computer performs a series of processing described later according to the server processing programs stored in the storage unit 42. In the series of processing, the system control unit 43 functions as an information acquisition unit 43a, an event presence determination unit 43b, a processing unit 43c, an information specification unit 43d, a condition determination unit 43e, and the like as illustrated in FIG. 4B. The information acquisition unit 43a is an exemplary acquisition means according to the present invention. The event presence determination unit 43b is an exemplary determination means according to the present invention. The processing unit 43c is an exemplary processing means according to the present invention. The information specification unit 43d is an exemplary specification means according to the present invention. The condition determination unit 43e is an exemplary condition determination means according to the present invention.

The information acquisition unit 43a acquires log data transmitted from the non-contact IC chip 1a in the electronic money card 1 via the portable terminal 3. An event, which is not grasped yet by the company managing the electronic money server 4, can be grasped earlier due to the log data. The event presence determination unit 43b determines whether an event (such as transaction or charge) corresponding to log data not managed by the electronic money server 4 yet is present based on the log data managed by the electronic money server 4 by use of the log database 42c and the log data acquired by the information acquisition unit 43a. That is, a determination is made as to whether the transaction or charge has been actually performed. For example, the event presence determination unit 43b acquires the log data including the electronic money number from the log database 42c with the electronic money number included in the log data acquired by the information acquisition unit 43a as a key, for example. The event presence determination unit 43b then determines whether an item of log data in the log data acquired from the non-contact IC chip 1a (or acquired by the information acquisition unit 43a) is included in the log data acquired from the log database 42c by comparing the contents of the log data, for example.

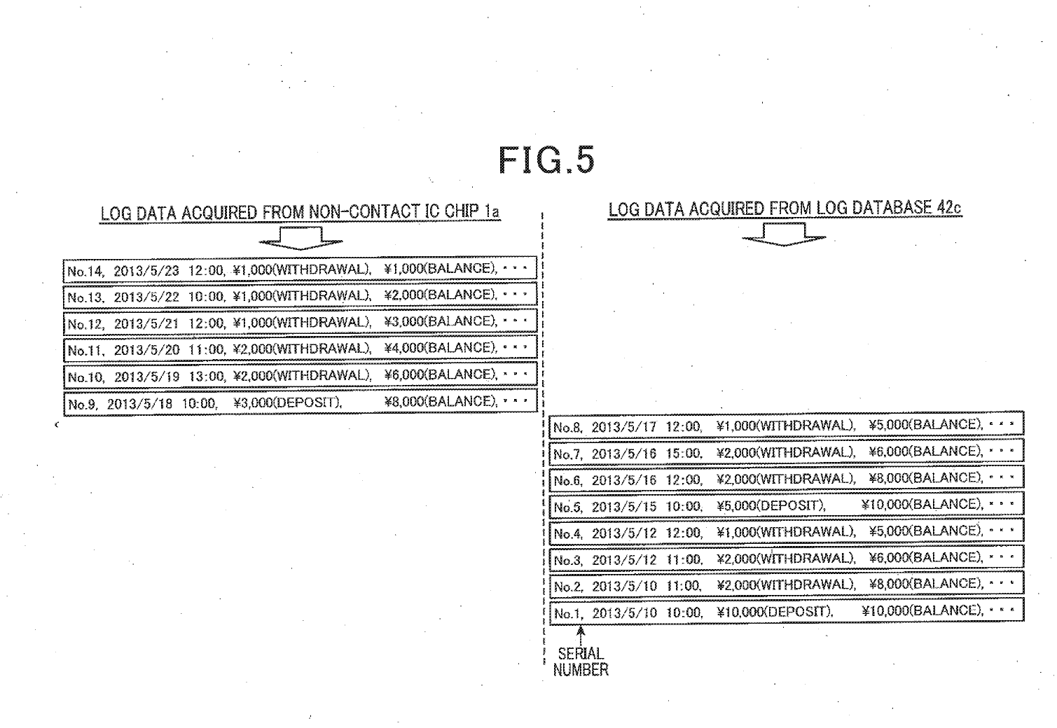

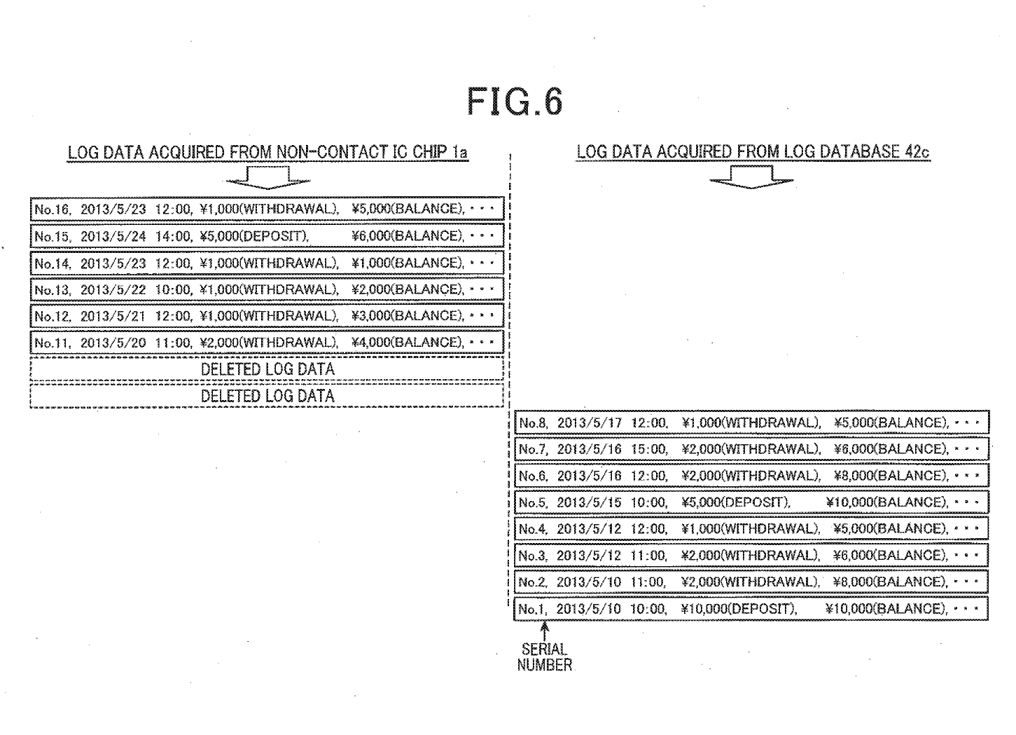

FIG. 5 is a diagram illustrating examples of the contents of the log data acquired from the non-contact IC chip 1a and the contents of the log data acquired from the log database 42c. FIG. 6 is a diagram illustrating other examples of the contents of the log data acquired from the non-contact IC chip 1a and the contents of the log data acquired from the log database 42c. “Deposit” in the examples of FIG. 5 and FIG. 6 indicates the charged amount, “withdrawal” indicates the transacted amount, and “balance” indicates a balance after transaction or charge. In the example of FIG. 5, all the log data acquired from the non-contact IC chip 1a is determined as not included in the log data acquired from the log database 42c. In this case, the log data acquired from the non-contact IC chip 1a is not managed by the electronic money server 4 yet. Therefore, the event presence determination unit 43b determines that an event (such as transaction or charge) corresponding to the log data not managed by the electronic money server 4 yet is present. It may be determined in some cases that only part of the log data acquired from the non-contact IC chip 1a is not included in the log data acquired from the log database 42c. In this case, an event corresponding to the part of the log data acquired from the non-contact IC chip 1a corresponds to the log data not managed by the electronic money server 4 yet.

On the other hand, also in the example of FIG. 6, all the log data acquired from the non-contact IC chip 1a is determined as not included in the log data acquired from the log database 42c, but in this case, there is log data deleted due to a limited amount of storage in the non-contact IC chip 1a. The deleted log data is not acquired from the non-contact IC chip 1a. The events corresponding to the deleted log data are other than the events corresponding to the log data acquired from the non-contact IC chip 1a, and correspond to the log data not managed by the electronic money server 4 yet. The event presence determination unit 43b can determine (estimate) whether an event other than the events corresponding to the log data acquired from the non-contact IC chip 1a (or an event corresponding to the log data deleted from the non-contact IC chip 1a) is present as the event corresponding to the log data not managed by the electronic money server 4 yet. For example, as illustrated in FIG. 6, when each item of log data includes a serial number, the events corresponding to the missing log data are estimated by use of the continuity of the serial numbers. In the example of FIG. 6, the log data No. 9 and No. 10 are missing between the serial numbers No. 8 and No. 11, and the presence of the events corresponding to the log data No. 9 and No. 10 is estimated. Further, as illustrated in FIG. 6, when each item of log data includes the balance after the event, the events corresponding to the missing log data can be estimated by use of a transition of the balance. In the example of FIG. 6, the balance after the event of the log data with the serial number No. 8 (the latest log data managed by the electronic money server 4) is \5,000, the transacted amount of the log data with the serial number No. 11 (the oldest log data acquired from the non-contact IC chip 1a) is \2,000 (withdraw), and the balance after the transaction is \4,000. In this case, at least one transaction and the use of at least \1,000 are estimated after the transaction corresponding to the latest log data managed by the electronic money server 4 and before the transaction corresponding to the oldest log data acquired from the non-contact IC chip 1a.

When the event presence determination unit 43b determines that the events are present, the processing unit 43c performs the processing assuming the presence of the events. The processing of registering predetermined information, providing information, or the like is generally performed based on the events corresponding to the log data managed by the electronic money server 4, but the processing unit 43c according to the present exemplary embodiment performs the processing in consideration of the events corresponding to the log data (or the log data acquired from the non-contact IC chip 1a) not managed by the electronic money server 4 yet but to be sent from the payment terminal 2 in the future. As an example of the processing assuming the events, there is a processing of providing the user with provision information capable of being provided to the user of the electronic money card 1 (the non-contact IC chip 1a) when a predetermined condition is met assuming the presence of the events determined by the event presence determination unit 43b. In other words, the processing is directed for providing the user with provision information capable of being provided to the user of the electronic money card 1 (the non-contact IC chip 1a) only assuming the presence of the events determined by the event presence determination unit 43b. Thereby, the provision information can be provided to the user at a conventionally-impossible timing. That is, the information, which cannot be conventionally provided to the user due to the data processing (such as the payment service providing company) even if a predetermined condition is already met, can be quickly provided to the user according to the present exemplary embodiment.

The predetermined condition may be a condition to provide benefit information, a condition to apply to a campaign, and the like. More specifically, at least one of the conditions such as period, place, number of times, and amount is set. For example, there is set a condition α that “transacted x times (or charged x times) (number of times) at the shop xx (or more than x shops) (place) within the latest x months (period).” Alternatively, there is set a condition β that “x yen was transacted (or x yen was charged) (amount) at the shop xx (or more than x shops) (place) within the latest x months (period).”

The information specification unit 43d specifies information enough to determine whether the predetermined condition is met. For example, for the condition α, the information specification unit 43d sums and specifies “period, place, and number of times” as the enough information based on the log data acquired from the non-contact IC chip 1a and the log data acquired from the log database 42c. The condition determination unit 43e then determines whether the predetermined condition is met based on the contents specified by the information specification unit 43d.

A predetermined condition may not be met even assuming the presence of the events determined by the event presence determination unit 43b (or the log data acquired from the non-contact IC chip 1a). In this case, for example, in order to meet a predetermined condition, another transaction or charge may be needed (or the number of lacking times is 1) or another \1, 000 needs to be transacted or charged (or the amount of shortage is 1,000 yen). Only when required for determining the predetermined condition as described above (or when a condition element to be met is lacking), the event presence determination unit 43b may determine whether an event other than the events corresponding to the log data acquired from the non-contact IC chip 1a is present. Thereby, it is possible to reduce a processing load for estimating whether an event other than the events corresponding to the log data is present. An event other than the events corresponding to the log data is an event corresponding to the log data deleted from the non-contact IC chip 1a, and thus the system control unit 43 cannot specify the specific contents of the event. Therefore, the information specification unit 43d specifies information enough to determine whether the predetermined condition is met (for example, the proposition that the number of times of transaction or charge is the number of lacking times or more is true, or the proposition that the amount transacted or charged is the lacking amount or more is true) based on at least one of the log data acquired from the non-contact IC chip 1a, and the serial numbers of the log data as well as the balance after the events acquired from the log database 42c (as described above, by use of the continuity of the serial numbers or a transition of the balance after the events). Thereby, it is possible to appropriately specify the information enough to determine whether a predetermined condition is met. The condition determination unit 43e then determines whether the predetermined condition is met based on the contents specified by the information specification unit 43d. Thereby, a condition determination may be made also assuming the events corresponding to the log data deleted from the non-contact IC chip 1a.

When a predetermined condition is not met even assuming the presence of the events determined by the event presence determination unit 43b, the processing unit 43c may perform the processing of providing the user with the information indicating the items required for meeting the predetermined condition assuming the presence of the events. For example, if another transaction or charge is needed for meeting a predetermined condition, the processing unit 43c provides the user with the information that “another transaction or charge meets a condition to provide benefit information” as the information indicating the required item. Thereby, the user can be promoted to make a transaction or charge by use of the electronic money card 1.

### [2. Operations of Electronic Money System S]

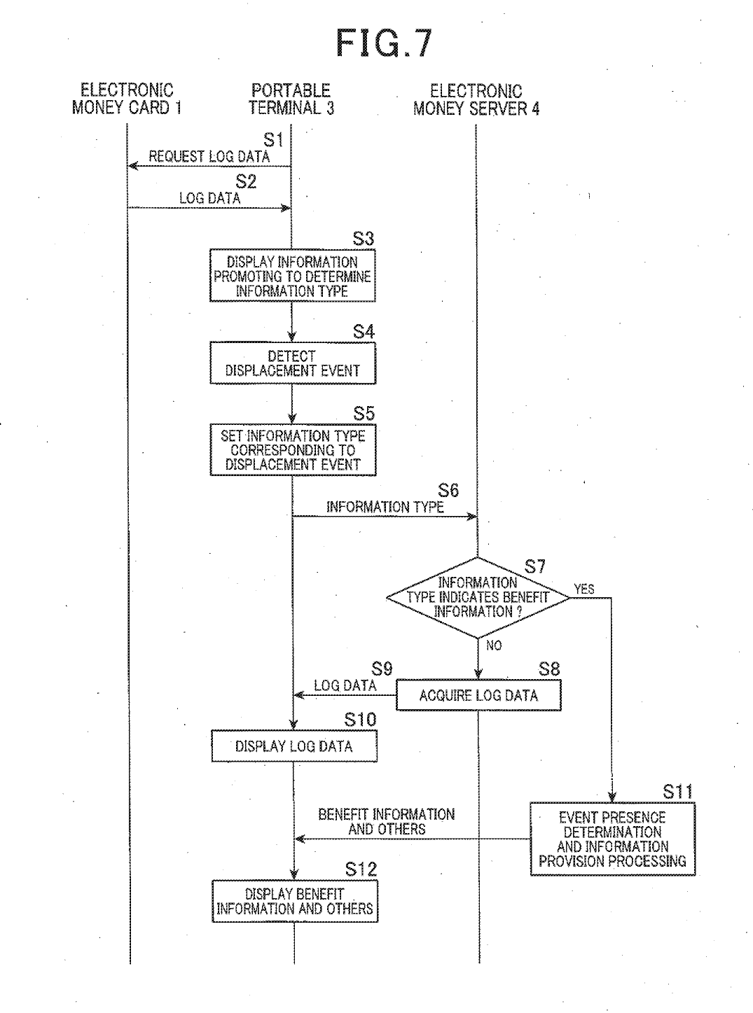

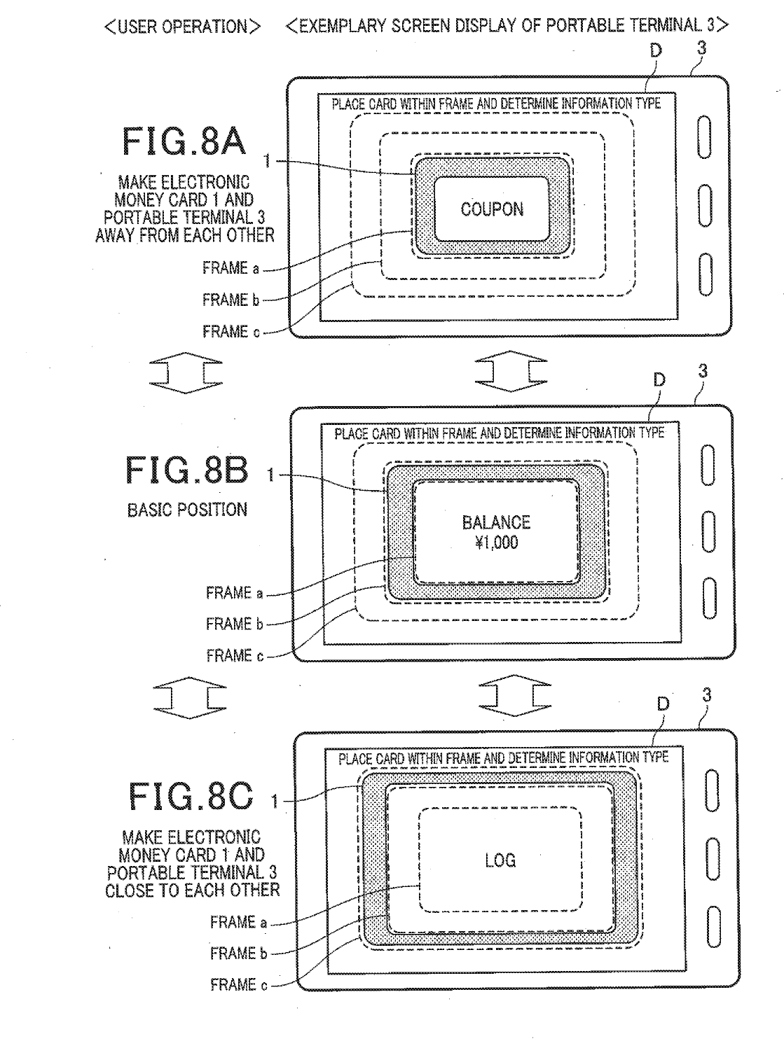

The operations of the electronic money system S according to the present exemplary embodiment will be described below with reference to FIG. 7, and FIGS. 8A to 8C. FIG. 7 is a sequence diagram illustrating the exemplary operations performed in the electronic money system S. FIGS. 8A to 8C are the diagrams illustrating exemplary screen display on the display D of the portable terminal 2.

In FIG. 7, when the user first makes the electronic money card 1 and the portable terminal 3 close to a near field communicable range and makes a predetermined instruction (such as an instruction of confirming the balance of the electronic money card 1) via the operation unit 34, the portable terminal 3 activates the camera 31, and requests (in a read command according to the present exemplary embodiment) the log data to the electronic money card 1 via the near field wireless communication unit 36 (step S1). The non-contact IC chip 1a in the electronic money card 1 reads the electronic money number together with the log data stored in the storage unit and transmits them to the portable terminal 3 in response to the log data request (step S2).

The portable terminal 3 acquires the electronic money number together with the log data from the electronic money card 1. The portable terminal 3 may request the balance data to the electronic money card 1 separately from the log data request, and acquire the balance data from the electronic money card 1. The portable terminal 3 then displays the balance included in the acquired log data (or the balance indicated by the balance data) and the information promoting the user to determine a desired information type on the display D (step S3). In the examples of FIGS. 8A to 8C, in order to align with the basic position illustrated in FIG. 8B, the user adjusts a relative position relationship between the electronic money card 1 and the portable terminal 3 such that the edge of the electronic money card 1 is between the frame a and the frame b displayed on the display D. The user then changes the relative position relationship between the electronic money card 1 and the portable terminal 3 to correspond to the desired information type. For example, when the user wants to display benefit information such as coupon, he/she makes the electronic money card 1 and the portable terminal 3 vertically away from each other such that the edge of the electronic money card 1 is within the frame a displayed on the display D (FIG. 8A). On the other hand, for example, when the user wants to display the contents of the log data, he/she makes the electronic money card 1 and the portable terminal 3 vertically close to each other such that the edge of the electronic money card 1 is between the frame b and the frame c displayed on the display D (FIG. 8C). In this way, when the relative position relationship between the electronic money card 1 and the portable terminal 3 is changed, the portable terminal 3 determines a part of interest from a reference image configuring a series of images captured from the camera 31, and detects a first displacement event or a second displacement event indicating that the determined part of interest is displaced in any of a plurality of comparative images following the reference image as described above (step S4).

Then, for example, as illustrated in FIG. 8A or 8C, when the relative position relationship between the electronic money card 1 and the portable terminal 3 is changed and the screen of the display D is then tapped, for example, the portable terminal 3 sets an information type corresponding to the detected first displacement event or second displacement event (step S5). The portable terminal 3 then accesses the electronic money server 4 via the near field wireless communication unit 36, and transmits the electronic money number acquired from the electronic money card 1 and the information indicating the set information type to the electronic money server 4 (step S6). Herein, when the first displacement event is set, the log data acquired from the electronic money card 1 is transmitted together with the information indicating the set information type to the electronic money server 4.

When acquiring the electronic money number and the information indicating the information type from the portable terminal 3, the electronic money server 4 determines whether the information type indicates benefit information (step S7). When determining that the information type does not indicate benefit information (step S7: NO), the electronic money server 4 acquires the log data including the acquired electronic money number from the log database 42c (step S8), and transmits the log data as provision information to the portable terminal 3 (step S9). Then, when acquiring the log data from the electronic money server 4, the portable terminal 3 integrates the acquired log data and the log data acquired from the electronic money card 1 to be displayed on the display D (step S10). For example, a list of the log data No. 1 to No. 14 illustrated in FIG. 5 is displayed. On the other hand, when determining that the information type indicates benefit information (step S7: YES), the electronic money server 4 makes the event presence determination and performs the information provision processing (step S11).

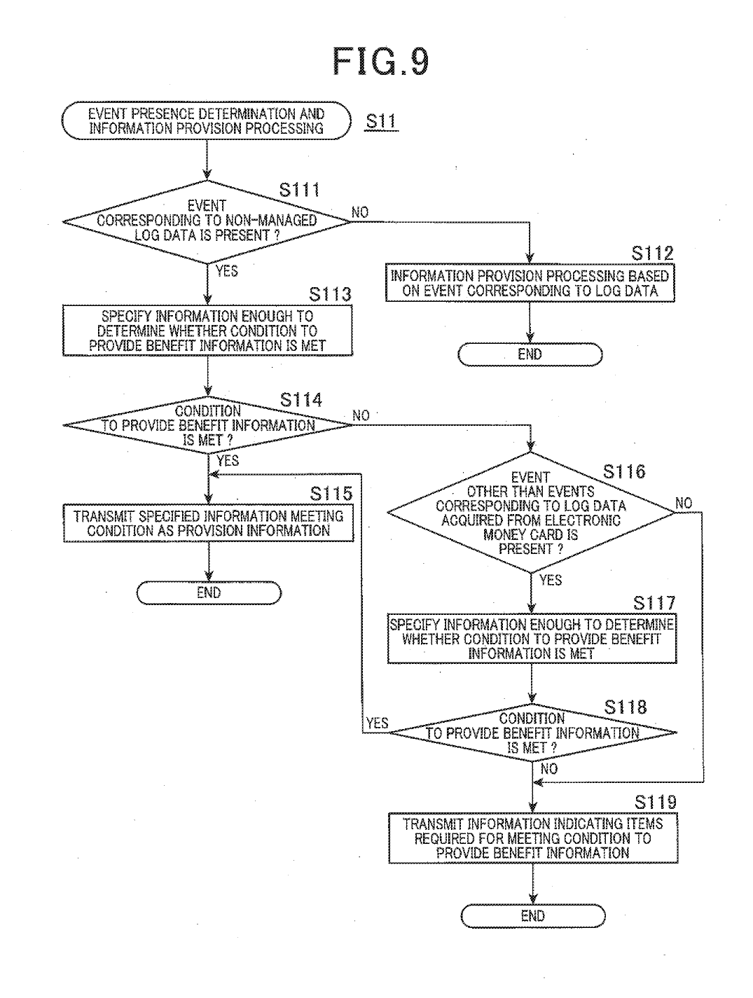

FIG. 9 is a flowchart illustrating the event presence determination and the information provision processing by way of example. As illustrated in FIG. 9, the electronic money server 4 determines, by the event presence determination unit 43b, whether an event corresponding to log data not managed by the electronic money server 4 yet is present based on the log data managed by the electronic money server 4 and the log data acquired from the electronic money card 1 via the portable terminal 3 as described above (step S111). In step S111, it is desirable to set such that a determination as to whether an event other than the events corresponding to the log data acquired from the electronic money card 1 via the portable terminal 3 is present is not made. When it is determined that an event corresponding to log data not managed by the electronic money server 4 yet is not present (step S111: NO), the information provision processing based on the events corresponding to the log data managed by the electronic money server 4 is performed (step S112).

On the other hand, when determining that an event corresponding to log data not managed by the electronic money server 4 yet is present (step S111: YES), the electronic money server 4 specifies information enough to determine whether a condition to provide the benefit information is met based on the log data managed by the electronic money server 4 and the log data acquired from the electronic money card 1 (step S113). The electronic money server 4 then determines, by the condition determination unit 43e, whether the condition to provide the benefit information is met based on the contents specified in step S103 (step S114). When determining that the condition to provide the benefit information is met assuming the presence of the determined events (step S114: YES), the electronic money server 4 transmits the specified information under the condition as provision information to the portable terminal 3 (step S115).

On the other hand, when determining the condition to provide the benefit information is not met (step S114: NO), the electronic money server 4 determines whether an event other than the events corresponding to the log data acquired from the electronic money card 1 is present as described above (step S116). When it is determined that an event other than the events corresponding to the log data acquired from the electronic money card 1 is present (step S116: YES), the processing proceeds to step S117. On the other hand, when it is determined that an event other than the events corresponding to the log data acquired from the electronic money card 1 is not present (step S116: NO), the processing proceeds to step S119.

In step S117, the electronic money server 4 specifies information enough to determine whether the condition to provide the benefit information is met based on at least one of the log data managed by the electronic money server 4, and the serial numbers of the log data acquired from the electronic money card 1 as well as the balance after the events as described above. The electronic money server 4 then determines, by the condition determination unit 43e, whether the condition to provide the benefit information is met based on the contents specified in step S117 (step S118). When it is determined that the condition to provide the benefit information is met (step S118: YES), the specified information under the condition is transmitted as the provision information to the portable terminal 3 (step S115). On the other hand, when it is determined that the condition to provide the benefit information is not met (step S118: NO), the processing proceeds to step S119. Then in step S119, the electronic money server 4 transmits the information indicating the items required for meeting the condition to provide the benefit information to the portable terminal 3. Then, when acquiring the benefit information or the information indicating the required items from the electronic money server 4, the portable terminal 3 displays the benefit information or the information indicating the required items on the display D (step S12). As described above, the user changes the relative position relationship between the electronic money card 1 and the portable terminal 3 so that the display of the benefit information and the display of the contents of the log data are switched.

As described above, according to the exemplary embodiment of the present invention, there is configured such that a determination is made as to whether an event corresponding to log data not managed by the electronic money server 4 yet is present based on the log data managed by the electronic money server 4 and the log data acquired from the electronic money card 1, and when it is determined that the event is present, the processing assuming the presence of the event is performed, and thus a predetermined processing depending on an event already occurring but not managed by the company managing the electronic money server 4 can be performed.

When receiving the log data transmitted by the batch processing in the payment terminal 2, for example, the electronic money server 4 checks the presence of an unauthorized event based on the transitions of the balances after the events in the log data and the log data acquired from the electronic money card 1. For example, when the transition of the balance after the events in the log data from the payment terminal 2 does not match with the transition of the balance after the events in the log data acquired from the electronic money card 1 (or the transitions of the balances are contradictory), the electronic money server 4 registers the contradictory log data as the log data having an unauthorized event, and outputs an alarm to the outside. Thereby, unauthorized use of the electronic money (such as double withdrawal or unauthorized withdrawal) can be notified to the user or the like, for example.

According to the exemplary embodiment, there has been described the case in which the present invention is applied to the electronic money system S using stored value type prepaid electronic money; however, the present invention is applicable to other information processing systems. For example, the present invention is applicable also to the systems using stored value type postpaid electronic money. Exemplary systems employing the stored value type postpaid electronic money may include a payment processing system using a credit card for recording the balance of the credit (limited amount) (or the consumed amount of the credit) or the log data in an IC module, and the like.

### REFERENCE SIGNS LIST

1: Electronic money card
2: Payment terminal
3: Portable terminal
4: Electronic money server
41: Communication unit
42: Storage unit
43: System control unit
44: Bus

1. A computer architecture for managing time-series information generated for events using a portable device, comprising:
at least one memory configured to store computer program code;
at least one processor configured to read said computer program code and operate as instructed by said computer program code, said computer program code including:
first receiving code configured to cause the at least one processor to receive the time-series information from a shop terminal which generates the time-series information;
second receiving code configured to cause the at least one processor to receive time-series information stored in the portable device from the portable device storing the time-series information generated for events using the portable device;
determination code configured to cause the at least one processor to determine whether an event corresponding to time-series information not yet received from the shop terminal and not yet managed by the computer architecture is present based on the time-series information received from the shop terminal by the first receiving code and managed by the computer architecture and the time-series information received from the portable device by the second receiving code; and
processing code configured to cause the at least one processor to, when the determination code causes the at least one processor to determine that the event is present, perform a processing assuming the presence of the event.

2. The computer architecture according to claim 1,
wherein the processing code causes the at least one processor to perform a processing of providing a user with provision information capable of being provided to the user of the portable device when a predetermined condition is met assuming the presence of the event determined by the determination code.

3. The computer architecture according to claim 2,
wherein the number of items of the time-series information capable of being stored in the portable device is limited to a predetermined number of items, and
the determination code causes the at least one processor to determine whether an event other than the events corresponding to the time-series information received by the second receiving code is present only when required for determining the predetermined condition.

4. The computer architecture according to claim 2, wherein the computer program code further includes:
specification code configured to cause the at least one processor to specify information enough to determine whether the predetermined condition is met; and
condition determination code configured to cause the at least one processor to determine whether the predetermined condition is met based on the specified contents.

5. The computer architecture according to claim 4,
wherein the time-series information includes at least one of the serial numbers of the time-series information per portable device and the balance after the events corresponding to the time-series information, and
the specification code causes the at least one processor to specify information enough to determine whether the predetermined condition is met based on at least one of the serial numbers of the time-series information and the balance.

6. The computer architecture according to claim 2,
wherein when the predetermined condition is not met, the processing code causes the at least one processor to perform a processing of providing the user with information indicating items required for meeting the predetermined condition assuming the presence of the event.

7. The computer architecture according to claim 1,
wherein when a predetermined condition is not met even assuming the presence of the event determined by the determination code, the processing code causes the at least one processor to perform a processing of providing the user with information indicating items required for meeting the predetermined condition assuming the presence of the event.

8. The computer architecture according to claim 1,
wherein the determination code causes the at least one processor to determine whether an event other than the events corresponding to the time-series information received by the second receiving code is present.

9. The computer architecture according to claim 8,
wherein the time-series information includes the balance after the events corresponding to the time-series information,
the computer program code further includes check code configured to cause the at least one processor to check the presence of an unauthorized event based on a transition of the balance.

10. An information processing method performed by an computer architecture for managing time-series information generated for events using a portable device, the method comprising:
a first receiving step of receiving the time-series information from a shop terminal which generates the time-series information;
a second receiving step of receiving time-series information stored in the portable device from the portable device storing the time-series information generated for events using the portable device;
a determination step of determining whether an event corresponding to time-series information not yet received from the shop terminal and not yet managed by the computer architecture is present based on the time-series information received from the shop terminal in the first receiving step and managed by the computer architecture and the time-series information received from the portable device in the second receiving step; and
a processing step of, when the event is determined as present in the determination step, performing a processing assuming the presence of the event.

11. (canceled)

12. A non-transitory storage medium storing an information processing program for causing a computer for managing time-series information generated for events using a portable device to perform:
a first receiving step of receiving the time-series information from a shop terminal which generates the time-series information;
a second receiving step of receiving time-series information stored in the portable device from the portable device storing the time-series information generated for events using the portable device;
a determination step of determining whether an event corresponding to time-series information not yet received from the shop terminal and not yet managed by the computer architecture is present based on the time-series information received from the shop terminal in the first receiving step and managed by the computer architecture and the time-series information received from the portable device in the second receiving step; and
a processing step of, when the event is determined as present in the determination step, performing a processing assuming the presence of the event.

13. The computer architecture according to claim 1,
wherein the first receiving code causes the at least one processor to receive the time-series information transmitted from the shop terminal at every predetermined time by a batch processing.

14. The computer architecture according to claim 1,
wherein the second receiving code causes the at least one processor to receive the time-series information transmitted from the portable device in response to user's instruction of the portable device.
